(19) United States
(12) Patent Application Publication
(10) Pub. No.: US 2013/0129015 A1
(43) Pub. Date: May 23, 2013

(54) METHOD AND APPARATUS FOR TRANSCEIVING A BROADCAST SIGNAL IN A DIGITAL BROADCAST SYSTEM

(71) Applicants: Jae-Hyun Seo, Daejeon (KR); Heung-Mook Kim, Daejeon (KR); Sung-Ik Park, Daejeon (KR); Ho-Min Eum, Daejeon (KR); Hyoungsoo Lim, Daejeon (KR); Soo-In Lee, Daejeon (KR)

(72) Inventors: Jae-Hyun Seo, Daejeon (KR); Heung-Mook Kim, Daejeon (KR); Sung-Ik Park, Daejeon (KR); Ho-Min Eum, Daejeon (KR); Hyoungsoo Lim, Daejeon (KR); Soo-In Lee, Daejeon (KR)

(73) Assignee: Electronics and Telecommunications Research Institute, Daejeon (KR)

(21) Appl. No.: 13/813,267

(22) PCT Filed: Jul. 29, 2011
(86) PCT No.: PCT/KR2011/005611

§ 371 Date: Jan. 30, 2013

(30) Foreign Application Priority Data
Jul. 30, 2010 (KR) 10-2010-0074123

(51) Int. Cl. H04H 20/00

(52) U.S. Cl. CPC H04H 20/00
USPC 375/295; 375/316

(57) ABSTRACT

The present invention relates to a method and apparatus for transceiving a broadcast signal in a digital broadcast system. The method for transmitting a broadcast signal according to one embodiment of the present invention comprises the following steps: generating a main signal using main data; generating an additional signal, the power of which is lower than that of the main signal, using a plurality of additional data; generating an additional signal frame using the additional signal and a frame header; and generating a broadcast signal using the main signal and an additional signal frame. The frame header is used in selectively extracting the plurality of additional data from the additional signal frame. According to the present invention, additional data can be efficiently transmitted while maintaining compatibility with existing digital broadcasting systems.

### BACKGROUND OF THE INVENTION

1. Field of the Invention

Exemplary embodiments of the present invention relate to an apparatus and a method for transmitting/receiving broadcast signals, and more particularly, to an apparatus and a method for time-dividing additional data included in broadcast signals in a digital broadcasting system and for transmitting and receiving the time-divided additional data.

2. Description of Related Art

An ATSC based DTV transmission system that is a terrestrial digital broadcasting system adopted in U.S.A, Canada, Mexico, Korea, or the like, uses a 6 MHz band and has transmission capacity of 19.39 Mbp. However, in the case of the terrestrial broadcasting system such as DVB-T in Europe or ISDB-T in Japan, various transmission capacities may be selectively applied if necessary and low transmission capacity for movement reception or high transmission capacity for fixed reception according to a channel coding rate or modulation techniques (QPSK) (16QAM, 64QAM, or the like) may be selected.

In the ATSC based digital broadcasting system, Reed-Solomon coding and Trellis coding are applied to broadcast various videos, audios, data, or the like, within the fixed transmission capacity of 19.39 Mbps using MPEG-2 TS (transport system) multiplexing technology. Recently, an ATSC M/H (mobile/handheld) technology for movement reception has been suggested. The ATSC M/H applies a new channel coding technique to some MPEG-2 TSs for backward compatibility with the existing ATSC system, such that the transmission rate of video, audio, and data to be transmitted is reduced.

### SUMMARY OF THE INVENTION

An embodiment of the present invention is directed to provide an apparatus and a method for transmitting and receiving broadcast signals capable of effectively transmitting additional data while maintaining compatibility with the existing digital broadcasting system.

Further, another embodiment of the present invention is directed to provide a method and an apparatus for transmitting and receiving broadcast signals capable of selectively receiving desired additional data when a plurality of additional data are transmitted using a frame header.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a method for transmitting broadcast signals including a main data and a plurality of additional data, the method includes: generating main signals using the main data; generating additional signals having lower power than that of the main signal using the plurality of additional data; generating an additional signal frame using the additional signals and a frame header; and generating the broadcast signals using the main signals and the additional signal frame, wherein the frame header is used to selectively extract the plurality of additional data from the additional signal frame.

In accordance with another embodiment of the present invention, a method for receiving broadcast signals including a main data and a plurality of additional data, the method includes: extracting main signals and an additional signal frame included in the broadcast signals; extracting the main data from the main signals; extracting a frame header from the additional signal frame; and selectively extracting the plurality of additional data from the additional signal frame using the frame header.

In accordance with still another embodiment of the present invention, an apparatus for transmitting broadcast signals including a main data and a plurality of additional data, the apparatus includes: a main signal generation unit configured to generate main signals using the main data; an additional signal generation unit configured to generate additional signals having lower power than that of the main signals, using the plurality of additional data; an additional signal frame generation unit configured to generate an additional signal frame using the additional signals and a frame header; and a broadcast signal generation unit configured to generate the broadcast signals using the main signals and the additional signal frame, wherein the frame header is used to selectively extract the plurality of additional data from the additional signal frame.

In accordance with yet another embodiment of the present invention, an apparatus for receiving broadcast signals including a main data and a plurality of additional data, the apparatus includes: a broadcast signal receiving unit configured to extract main signals and an additional signal frame included in the broadcast signals; a main data extraction unit configured to extract the main data from the main signals; a frame header extraction unit configured to extract a frame header from the additional signal frame; and an additional data extraction unit configured to selectively extract the plurality of additional data from the additional signal frame using the frame header.

### BRIEF DESCRIPTION OF THE DRAWINGS

FIG. 1 is a configuration diagram of an apparatus for transmitting broadcast signals transmitting additional data while maintaining with backward compatibility with the existing broadcasting system.

FIG. 2 is a configuration diagram of an apparatus for receiving additional data while maintaining backward compatibility with the existing broadcasting system.

FIG. 3 is a graph for comparing power to transmission time of main signals and additional signals transmitted and received through the apparatus for transmitting broadcast signals of FIG. 1 and the apparatus for receiving broadcast signals of FIG. 2.

FIG. 4 is a configuration diagram of an apparatus for transmitting a plurality of additional data using code division while maintaining backward compatibility with the broadcasting system in accordance with the related art.

FIG. 5 is a configuration diagram of an apparatus for receiving a plurality of additional data transmitted using code division while maintaining backward compatibility with the broadcasting system in accordance with the related art.

FIG. 6 is a graph for comparing power to transmission time of main signals and additional signals transmitted and received through the apparatus for transmitting broadcast signals of FIG. 4 and the apparatus for receiving broadcast signals of FIG. 5.

FIG. 7 is a configuration diagram of an apparatus for transmitting broadcast signals in accordance with the embodiment of the present invention.

FIG. 8 is a configuration diagram of an apparatus for transmitting broadcast signals in accordance with another embodiment of the present invention.

FIG. 9 is a diagram illustrating a configuration of an apparatus for receiving broadcast signals in accordance with the embodiment of the present invention.

FIG. 10 is a configuration diagram of an apparatus for receiving broadcast signals in accordance with another embodiment of the present invention.

FIG. 11 is a graph for comparing power to transmission time of main signals and additional signals transmitted and received by an apparatus for transmitting broadcast signals and an apparatus for receiving broadcast signals in accordance with the embodiment of the present invention.

FIG. 12 is a graph for describing a method for selectively extracting additional signals transmitted by time division using an additional signal frame transmitted by the embodiment of the present invention.

FIG. 13 is a flow chart of a method for transmitting broadcast signals in accordance with the embodiment of the present invention.

FIG. 14 is a flow chart of a method for receiving broadcast signals in accordance with the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

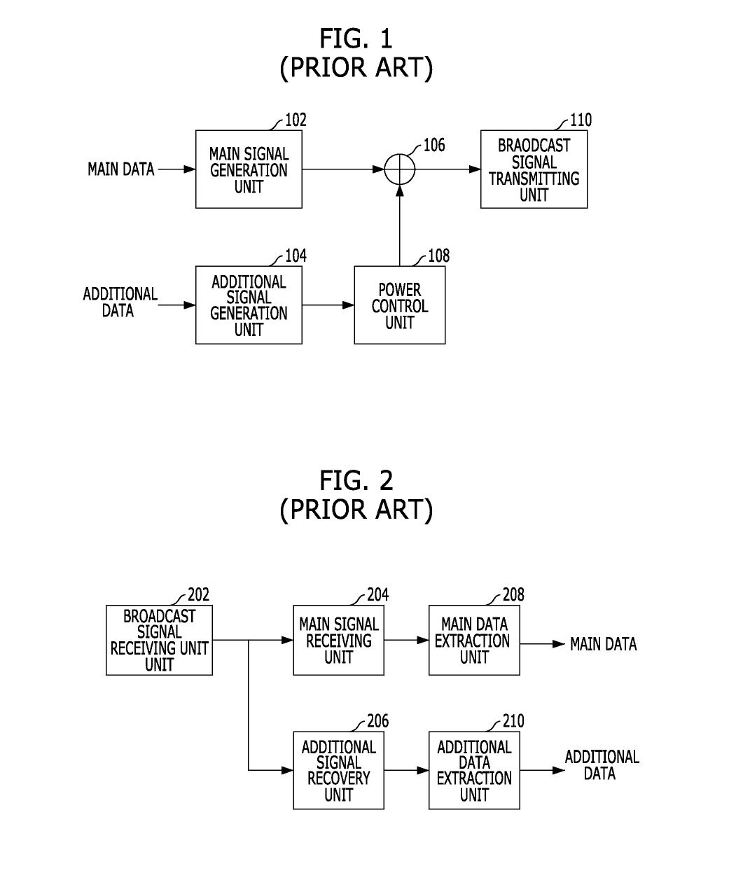

FIG. 1 is a configuration diagram of an apparatus for transmitting broadcast signals transmitting additional data while maintaining with backward compatibility with the existing broadcasting system.

As illustrated in FIG. 1, a main data including video, audio, data, or the like, for digital broadcasting is input to a main signal generation unit 102. The main signal generation unit 102 applies channel coding to the input main data and converts the coded main data into an MPEG-2 TS type, thereby generating the main signals.

Meanwhile, the additional data other than the main data are input to the additional signal generation unit 104. The additional signal generation unit 104 generates additional signals by applying new channel coding to the input additional data, independent from the channel coding applied to the main signals.

The additional signals generated from the additional signal generation unit 104 are input to a power control unit 108. The power control unit 108 controls power of the input additional signals so as to be sufficiently lower than that of the main signals generated from the main signal generation unit 102.

An addition unit 106 adds the main signals generated from the main signal generation unit 102 and the additional signals output from the power control unit 108, thereby generating the broadcast signals. The broadcast signal generated from the addition unit 106 is input to the broadcast signal transmitting unit 110. The broadcast signal transmitting unit 110 modulates the input broadcast signal according to a broadcast standard. The modulated broadcast signals are broadcast through a transmitting antenna.

In this configuration, since the additional signals generated through the additional signal generation unit 104 and the power control unit 108 has sufficiently lower power than that of the main signals, the additional signals may have backward compatibility with the existing broadcast signals.

FIG. 2 is a configuration diagram of an apparatus for receiving additional data while maintaining backward compatibility with the existing broadcasting system.

As illustrated in FIG. 2, the broadcast signals received through the receiving antenna are input to a broadcast signal receiving unit 202. The broadcast signal receiving unit 202 demodulates the received broadcast signals and inputs the demodulated broadcast signals to a main signal recovery unit 204 and an additional signal recovery unit 206.

The main signal recovery unit 204 recovers the main signals using the input signals. Further, a main data extraction unit 208 applies channel decoding to the recovered main signal to generate the main data.

The additional signal recovery unit 206 removes the main signals from the input signals to recover the additional signals. The additional data extraction unit 210 applies the channel decoding to the recovered additional signal to extract the additional data.

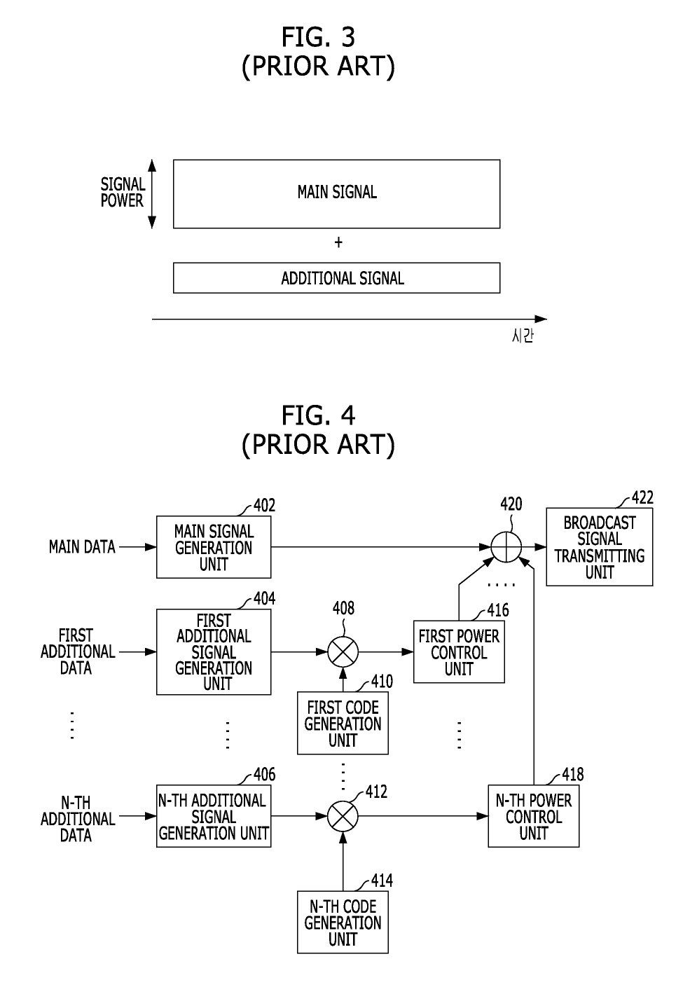

FIG. 3 is a graph for comparing power to transmission time of a main signal and an additional signal transmitted and received through the apparatus for transmitting broadcast signals of FIG. 1 and the apparatus for receiving broadcast signals of FIG. 2.

As illustrated in FIG. 3, the additional signals transmitted and received through the apparatus for transmitting broadcast signals of FIG. 1 and the apparatus for receiving broadcast signals of FIG. 2 have lower power than that of the main signals over the entire time. Therefore, the broadcast signals including the additional signals may maintain backward compatibility with the broadcast signals by the existing broadcast system.

FIG. 4 is a configuration diagram of an apparatus for transmitting a plurality of additional data using code division while maintaining backward compatibility with the broadcasting system in accordance with the related art.

As illustrated in FIG. 4, the main data including video, audio, data, or the like, for digital broadcasting is input to a main signal generation unit 402. The main signal generation unit 402 applies channel coding to the input main data and converts the coded main data into an MPEG-2 TS type, thereby generating the main signals.

Meanwhile, the plurality of additional data other than the main data, that is, a first additional data to an n-th additional data are each input to a first additional signal generation unit 404 to the n-th additional signal generation unit 406. The first additional signal generation unit 404 to an n-th additional signal generation unit 406 apply new channel coding to each of the input additional data, independent from the channel coding applied to the main signals to generate the first additional signal to the n-th additional signal. In this case, the channel coding applied in the first additional signal generation unit 404 to the n-th additional signal generation unit 406 may be the same as each other or may be different from each other.

Meanwhile, the first code generation unit 410 to the n-th code generation unit 414 each generates the first code to the n-th code. Further, each multiplier 408 to 412 multiplies the first additional signal to the n-th additional signal by a first code to an n-th code.

The first additional signal to the n-th additional signal output from each multiplier 408 to 412 are each input to a first power control unit 416 to an n-th power control unit 418. The first power control unit 416 to the n-th power control unit 418 controls power of the input additional signals so as to be sufficiently lower than that of the main signals generated from the main signal generation unit 102. In this case, the first power control unit 416 to the n-th power control unit 418 may each control the power of the additional signal to be the same as each other or different from each other.

The addition unit 420 adds the main signal generated from the main signal generation unit 402 to the first additional signal to the n-th additional signal output from the first power control unit 416 to the n-th power control unit 418 to generate the broadcast signals. The broadcast signals generated from the addition unit 420 are input to the broadcast signal transmitting unit 422. The broadcast signal transmitting unit 422 modulates the input broadcast signal according to a broadcast standard. The modulated broadcast signals are broadcast through the transmitting antenna.

In this case, a sum of the power of the first additional signal to the n-th additional signal output from the first power control unit 416 to the n-th power control unit 418 is sufficiently lower than that of the main signal, thereby implementing the backward compatibility with the existing broadcast signal.

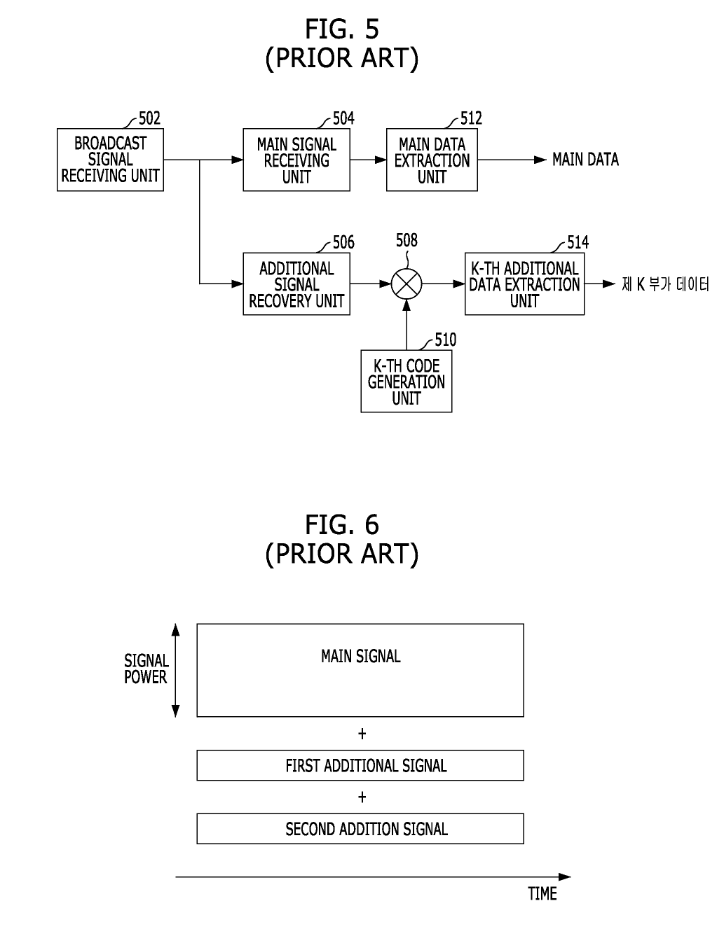

FIG. 5 is a configuration diagram of an apparatus for receiving a plurality of additional data transmitted using code division while maintaining backward compatibility with the broadcasting system in accordance with the related art.

As illustrated in FIG. 5, the broadcast signals received through the receiving antenna are input to a broadcast signal receiving unit 502. The broadcast signal receiving unit 502 demodulates the received broadcast signals and inputs the demodulated broadcast signals to a main signal recovery unit 504 and an additional signal recovery unit 506.

The main signal recovery unit 504 recovers the main signals using the input signals. Further, a main data extraction unit 512 applies the channel decoding to the recovered main signal to generate the main data.

The additional signal recovering unit 506 removes the main signals from the input signals to recover the additional signals. Meanwhile, a k-th code generation unit 510 generates a k-th code corresponding to one of the first code to the n-th code of the transmitting apparatus. The multiplier 508 multiplies the recovered additional signal by the k-th code to generate the k-th additional signal.

The k-th additional signal output from the multiplier 508 is input the k-th additional data extraction unit 514. The k-th additional data extraction unit 514 applies the channel decoding to the recovered additional signal to extract the additional data.

FIG. 6 is a graph for comparing power to transmission time of a main signal and an additional signal transmitted and received through the apparatus for transmitting broadcast signals of FIG. 4 and the apparatus for receiving broadcast signals of FIG. 5.

As illustrated in FIG. 6, the plurality of additional signals transmitted and received through the apparatus for transmitting broadcast signals of FIG. 4 and the apparatus for receiving broadcast signals of FIG. 5 have lower power than that of the main signals over the entire time. Therefore, the broadcast signals including the additional signals may maintain backward compatibility with the broadcast signals by the existing broadcast system. In FIG. 6, two additional signals are distinguished by different codes. In addition, the results similar to FIG. 6 are obtained even though at least two additional data are transmitted.

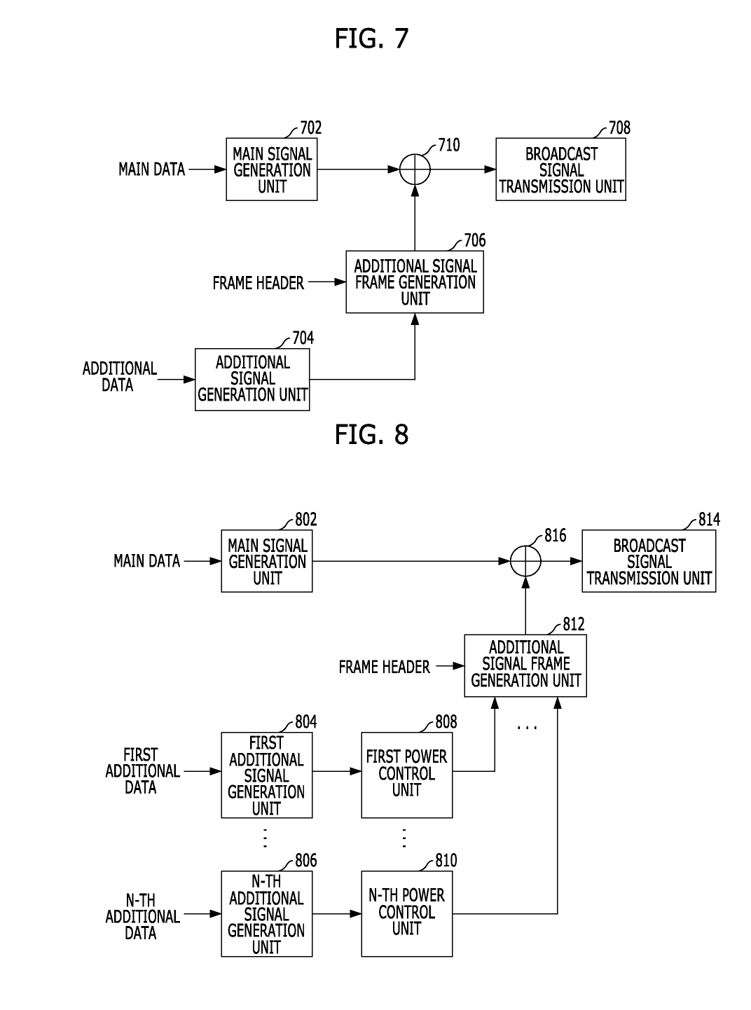

FIG. 7 is a configuration diagram of an apparatus for transmitting broadcast signals in accordance with the embodiment of the present invention.

In FIG. 7, the main data including video, audio, data, or the like, for digital broadcasting is input to a main signal generation unit 702. The main signal generation unit 702 applies channel coding to the input main data and converts the coded main data into an MPEG-2 TS type, thereby generating the main signals.

Meanwhile, the plurality of additional data other than the main data is input to the additional signal generation unit 704. The additional signal generation unit 704 generates the additional signals by applying new channel coding to the input additional data, independent from the channel coding applied to the main signals. In addition, the additional signal generation unit 704 controls the power of the input additional signals so as to be sufficiently lower than that of the main signals generated from the main signal generation unit 702.

The additional signal frame generation unit 706 generates the additional signal frame using a frame header and the additional signal generated from the additional signal generation unit 704. In this case, the frame header, which is a header included in the additional signal frame, may include at least one of information regarding the number of a plurality of additional data, information regarding a length of the plurality of additional data, and information regarding a position of the plurality of additional data. Therefore, the receiving apparatus uses the information included in the frame header to selectively extract the plurality of additional data from the received additional signal frame. Consequently, the additional signal frame includes the frame header and the plurality of time-divided additional data.

An addition unit 710 adds the main signals generated from the main signal generation unit 702 and the additional signal frame generated from the additional signal frame generation unit 706, thereby generating the broadcast signals. The broadcast signal transmitting unit 708 modulates the broadcast signals output from the addition unit 710 according to the broadcast standard and broadcasts the modulated broadcast signals.

In this configuration, since the additional signals generated through the additional signal generation unit 704 have sufficiently lower power than that of the main signals, the additional signals may have backward compatibility with the existing broadcast signals.

FIG. 8 is a configuration diagram of an apparatus for transmitting broadcast signals in accordance with another embodiment of the present invention.

In FIG. 8, the main data including video, audio, data, or the like, for digital broadcasting is input to a main signal generation unit 802. The main signal generation unit 802 applies channel coding to the input main data and converts the coded main data into an MPEG-2 TS type, thereby generating the main signals.

Meanwhile, the plurality of additional data other than the main data, that is, a first additional data to an n-th additional data are each input to a first additional signal generation unit 804 to an n-th additional signal generation unit 806. The first additional signal generation unit 804 to the n-th additional signal generation unit 806 apply new channel coding to each of the input additional data, independent from the channel coding applied to the main signals to generate the first additional signal to the n-th additional signal. In this case, the channel coding applied in the first additional signal generation unit 804 to the n-th additional signal generation unit 806 may be the same as each other or may be different from each other.

The first additional signal to the n-th additional signal output from the first additional signal generation unit 804 to the n-th additional signal generation unit 806 are each input to a first power control unit 808 to an n-th power control unit 810. The first power control unit 808 to the n-th power control unit 810 control power of the input additional signals so as to be sufficiently lower than that of the main signals generated from the main signal generation unit 802. In this case, the first power control unit 808 to the n-th power control unit 810 may each control the power of the additional signal to be the same as each other or different from each other.

The signals output from the first power control unit 808 to the n-th power control unit 810 are input to an additional signal frame generation unit 812. The additional signal frame generation unit 812 uses the plurality of input additional signals and the frame header to generate the additional signal frame. In this case, the frame header, which is a header included in the additional signal frame, may include at least one of information regarding the number of a plurality of additional data, information regarding a length of the plurality of additional data, and information regarding a position of the plurality of additional data. Therefore, the receiving apparatus uses the information included in the frame header to selectively extract the plurality of additional data from the received additional signal frame.

An addition unit 816 adds the main signals output from the main signal generation unit 802 and the additional signals generated from the additional signal frame generation unit 812, thereby generating the broadcast signals. The broadcast signal transmitting unit 814 modulates the broadcast signals output from the addition unit 816 according to the broadcast standard and broadcasts the modulated broadcast signals.

In this case, a sum of the power of the first additional signal to the n-th additional signal output from the first power control unit 808 to the n-th power control unit 810 is sufficiently lower than that of the main signal, thereby implementing the backward compatibility with the existing broadcast signal.

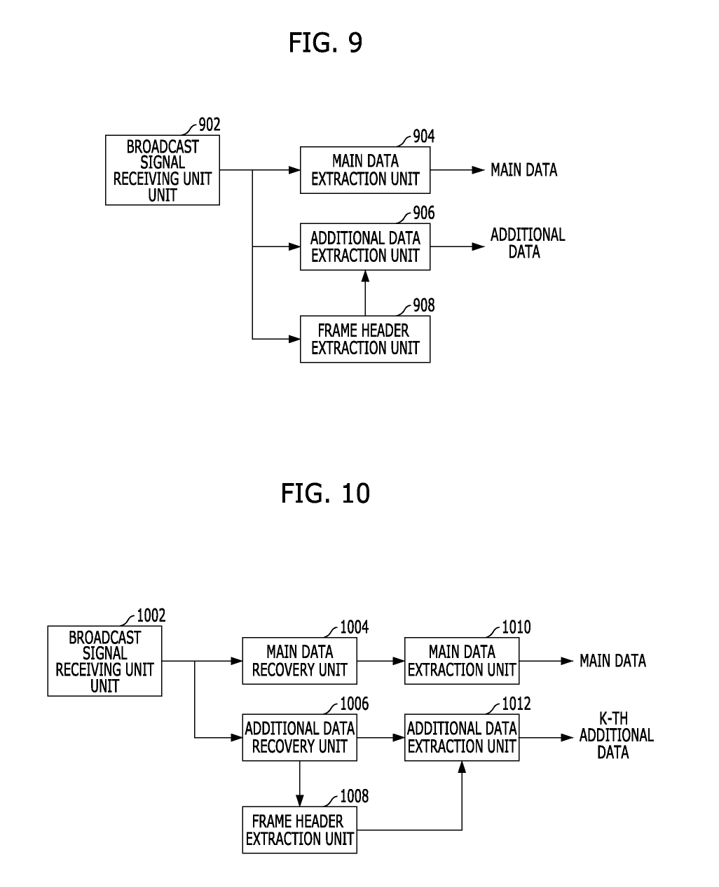

FIG. 9 is a diagram illustrating a configuration of an apparatus for receiving broadcast signals in accordance with the embodiment of the present invention.

In FIG. 9, the broadcast signals received through the receiving antenna are input to a broadcast signal receiving unit 902. A broadcast signal receiving unit 902 demodulates the received broadcast signals and inputs the demodulated broadcast signals to a main data extraction unit 904 and an additional data extraction unit 906.

The main data extraction unit 904 uses the input signals to recover the main signals and applies the channel decoding to the recovered main signals to extract the main data.

The frame header extraction unit 908 extracts the frame header from the additional signal frame included in the demodulated broadcast signals. As described above, the frame header, which is a header included in the additional signal frame, may include at least one of information regarding the number of a plurality of additional data, information regarding a length of the plurality of additional data, and information regarding a position of the plurality of additional data.

The additional data extraction unit 906 removes the main signals from the demodulated broadcast signals to recover the additional signal frame and applies the channel decoding to the additional signals included in the recovered additional signal frame to extract the additional data. In this case, the additional data extraction unit 906 uses the information included in the frame header extracted by the frame header extraction unit 908 to extract specific additional data, that is, a k-th additional data among the plurality of time-divided additional data included in the additional signal frame. That is, the additional data extraction unit 906 may detect the time, position, or the like, in the additional data frame to be extracted through the frame header and select the specific additional data through the detected information.

FIG. 10 is a configuration diagram of an apparatus for receiving broadcast signals in accordance with another embodiment of the present invention.

In FIG. 10, the broadcast signals received through the receiving antenna are input to a broadcast signal receiving unit 1002. The broadcast signal receiving unit 1002 demodulates the received broadcast signals and inputs the demodulated broadcast signals to a main signal recovery unit 1004 and an additional signal recovery unit 1006.

The main signal recovery unit 1004 recovers the main signals from the demodulated broadcast signals. Further, a main data extraction unit 1010 applies the channel decoding to the recovered main signal to extract the main data.

An additional signal recovery unit 1006 removes the main signals from the demodulated broadcast signals to recover the additional signal frame. Further, a frame header extraction unit 1008 extracts the frame header from the recovered additional signal frame. As described above, the frame header, which is a header included in the additional signal frame, may include at least one of information regarding the number of a plurality of additional data, information regarding a length of the plurality of additional data, and information regarding a position of the plurality of additional data.

An additional data extraction unit 1012 uses the information included in the frame header to detect the time, position, or the like, of the additional data to be extracted within the additional signal frame recovered in the additional signal recovery unit 1006, thereby selecting the k-th additional data. Then, the additional data extraction unit 1012 applies the channel decoding to the additional signals including the k-th additional data to extract the k-th additional data. As a result, the apparatus for receiving broadcast signals of FIG. 10 may select and extract the specific additional data, that is, the k-th additional data among the plurality of time-divided additional data.

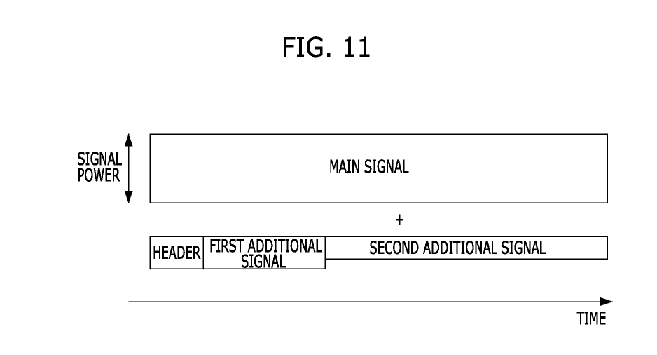

FIG. 11 is a graph for comparing power to transmission time of a main signal and an additional signal transmitted and received by an apparatus for transmitting broadcast signals and an apparatus for receiving broadcast signals in accordance with the embodiment of the present invention.

Referring to FIG. 11, power of a first additional signal, a second additional signal, and an additional signal frame (including a header, a first additional signal, and a second additional signal is independent from each other and is lower than that of the main signal. In addition, the first additional signal and the second additional signal are transmitted in different time domains. (That is, time division) FIG. 11 illustrates only two additional signals but the same results as illustrated in FIG. 11 are obtained even though at least two additional data are transmitted.

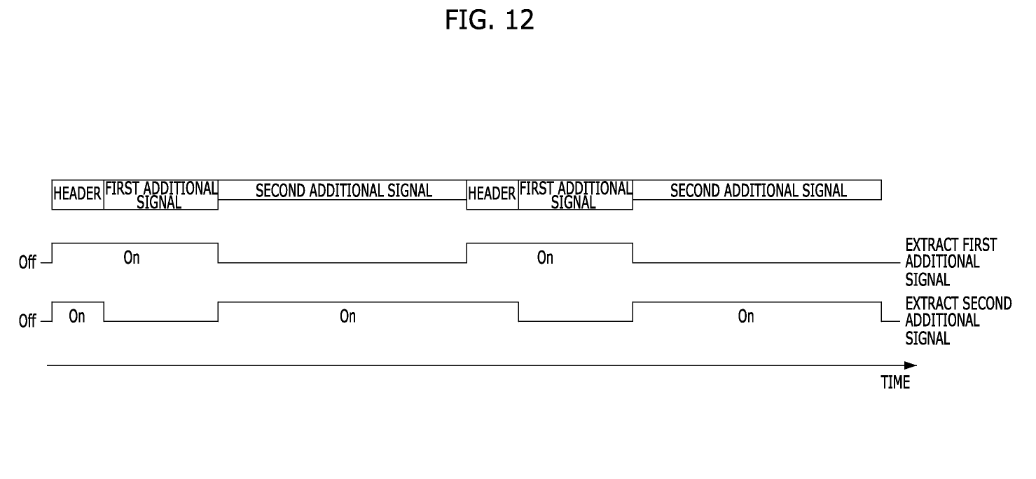

FIG. 12 is a graph for describing a method for selectively extracting additional signals transmitted by time division using an additional signal frame transmitted by the embodiment of the present invention.

As illustrated in FIG. 12, the plurality of time-divided data included in the additional signal frame in accordance with the embodiment of the present invention may be selectively extracted That is, the apparatus for receiving broadcast signals in accordance with the embodiment of the present invention extracts the additional signal frame header from the received broadcast signals and then, detects the time, position, or the like, of the additional signal including the additional data to be extracted to extract the specific additional data. In this case, as illustrated in FIG. 12, the power consumption of the receiver may be reduced by turning-on/off the operation of the receiving apparatus using the information included in the additional signal frame header.

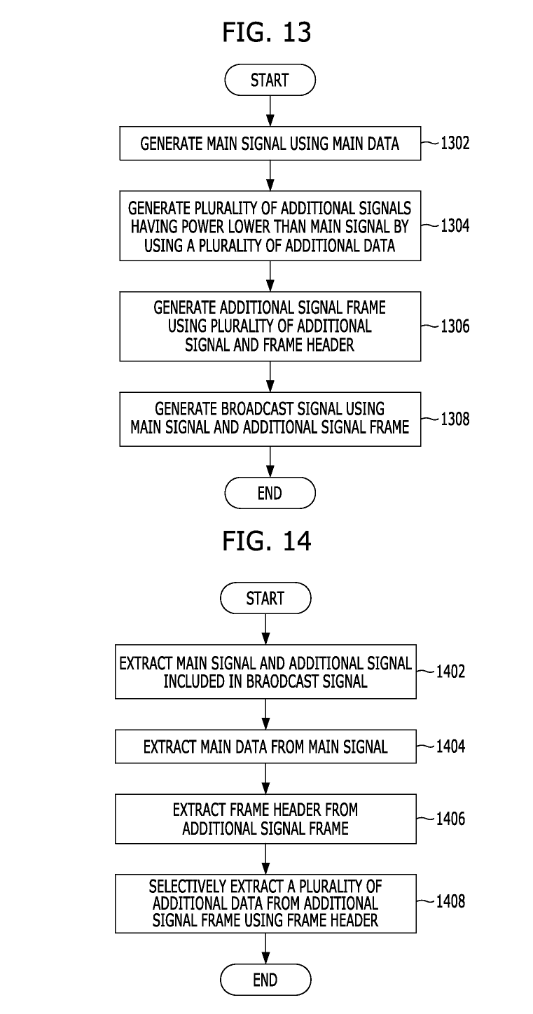

FIG. 13 is a flow chart of a method for transmitting broadcast signals in accordance with the embodiment of the present invention.

First, the main signals are generated using the main data (1302). Further, the plurality of additional signals having lower power than that of the main signals is generated using the plurality of additional data (1304).

Next, the additional signal frame is generated using the plurality of additional signals and the frame header (1306). In this case, the frame header, which is a header included in the additional signal frame, may include at least one of information regarding the number of a plurality of additional data, information regarding a length of the plurality of additional data, and information regarding a position of the plurality of additional data. Therefore, the receiving apparatus uses the information included in the frame header to selectively extract the plurality of additional data from the received additional signal frame.

Finally, the broadcast signals are generated using the main signal and the additional signal frame (1308). The generated broadcast signals may be modulated and broadcast according to the broadcasting standard.

FIG. 14 is a flow chart of a method for receiving broadcast signals in accordance with the embodiment of the present invention.

First, the main signals and the additional signal frame included in the broadcast signals are extracted (1402). Then, the main data is extracted from the main signals (1404) and the frame header is extracted from the additional signal frame (1406). In this case, the frame header, which is a header included in the additional signal frame, may include at least one of information regarding the number of a plurality of additional data, information regarding a length of the plurality of additional data, and information regarding a position of the plurality of additional data.

Further, the plurality of additional data is selectively extracted from the additional signal frame using the frame header (1408). For example, only the selected specific additional data may be extracted by detecting the position and the time of the specific additional data through the information included in the frame header.

According to the embodiment of the present invention, the power of the entire additional data may be lower than the existing method (code division) by time-dividing the plurality of additional data using the frame header. In addition, in accordance with the embodiment of the present invention, the plurality of additional data may be simultaneously transmitted by making the power of each additional data different from each other. In addition, in the case of the receiving apparatus, the specific additional data may be selectively received from the plurality of time-divided additional data by using the frame header information. As described above, when the plurality of additional data are selectively received, the power consumption of the receiving apparatus can be reduced.

As described above, the exemplary embodiment of the present invention can effectively transmit the additional data while maintaining compatibility with the existing digital broadcasting system.

In addition, the exemplary embodiment of the present invention can selectively receive the desired additional data when the plurality of additional data is transmitted by transmitting the additional data using the frame header.

While the present invention has been described with respect to the specific embodiments, it will be apparent to those skilled in the art that various changes and modifications may be made without departing from the spirit and scope of the invention as defined in the following claims.

What is claimed is:

1. A method for transmitting broadcast signals including a main data and a plurality of additional data, the method comprising:
generating main signals using the main data;
generating additional signals having lower power than that of the main signal using the plurality of additional data;
generating an additional signal frame using the additional signals and a frame header; and
generating the broadcast signals using the main signals and the additional signal frame,
wherein the frame header is used to selectively extract the plurality of additional data from the additional signal frame.

2. The method of claim 1, wherein the frame header includes at least one of information regarding the number of a plurality of additional data, information regarding a length of the plurality of additional data, and information regarding of a position of the plurality of additional data.

3. The method of claim 1, wherein the generating of the main signal includes applying channel coding to the main data.

4. The method of claim 1, wherein the generating of the additional signal includes:
applying channel coding to the plurality of main data; and
controlling the power of the additional signals so as to be lower than that of the main signal.

5. The method of claim 1, further comprising:
modulating the broadcast signals; and
transmitting the modulated broadcast signals.

6. A method for receiving broadcast signals including a main data and a plurality of additional data, comprising:
extracting main signals and an additional signal frame included in the broadcast signals;
extracting the main data from the main signals;
extracting a frame header from the additional signal frame; and
selectively extracting the plurality of additional data from the additional signal frame using the frame header.

7. The method of claim 6, wherein the frame header includes at least one of information regarding the number of a plurality of additional data, information regarding a length of the plurality of additional data, and information regarding of a position of the plurality of additional data.

8. The method of claim 6, wherein the extracting of the main data includes applying channel decoding to the main signals.

9. The method of claim 6, wherein the selectively extracting of the plurality of additional data includes:
extracting additional signals from the additional signal frame;
selecting additional data to be extracted among the plurality of additional data included in the additional signals by using the frame header; and
extracting the selected additional data by applying channel decoding to the additional signals.

10. The method of claim 6, wherein the extracting of the main signals and the additional signal frame included in the broadcast signals includes:
receiving the broadcast signals; and
demodulating the broadcast signals.

11. An apparatus for transmitting broadcast signals including a main data and a plurality of additional data, the apparatus comprising:
a main signal generation unit configured to generate main signals using the main data;
an additional signal generation unit configured to generate additional signals having lower power than that of the main signals, using the plurality of additional data;
an additional signal frame generation unit configured to generate an additional signal frame using the additional signals and a frame header; and
a broadcast signal generation unit configured to generate the broadcast signals using the main signals and the additional signal frame,
wherein the frame header is used to selectively extract the plurality of additional data from the additional signal frame.

12. An apparatus for receiving broadcast signals including a main data and a plurality of additional data, the apparatus comprising:
a broadcast signal receiving unit configured to extract main signals and an additional signal frame included in the broadcast signals;
a main data extraction unit configured to extract the main data from the main signals;
a frame header extraction unit configured to extract a frame header from the additional signal frame; and
an additional data extraction unit configured to selectively extract the plurality of additional data from the additional signal frame using the frame header.
